(19) United States
(12) Patent Application Publication
(10) Pub. No.: US 2010/0167151 A1
(43) Pub. Date: Jul. 1, 2010

(54) ION EXCHANGER FOR FUEL CELL VEHICLE

(76) Inventor: Junji Nagasawa, Shizuoka-ken (JP)

Correspondence Address: KENYON & KENYON LLP, 1500 K STREET N.W., SUITE 700, WASHINGTON, DC, 20005, US

(21) Appl. No.: 12/304,093

(22) PCT Filed: May 24, 2007
(86) PCT No.: PCT/JP2007/061040

§ 371 Date: Dec. 9, 2008

(30) Foreign Application Priority Data
Jun. 23, 2006 (JP) 2006-174438

(51) Int. Cl. H01M 8/04

(52) U.S. Cl. 429/437

(57) ABSTRACT

An ion exchanger comprises an ion exchange cartridge, and an ion exchanger bracket for connecting the ion exchange cartridge to a cooling water path to thereby hold the ion exchange cartridge so as to be freely removed. The ion exchanger bracket is provided at a position closer to the front end portion of the fuel cell vehicle, the position being on the side surface of the sub-frame. The cooling water path, connected to the ion exchanger bracket, is arranged so as to reach the motor room, penetrating the sub-frame. Also, because the ion exchanger is mounted in a space surrounded by the rear side of the bumper and an inner fender covering the rear side of the fender and a tire house, the ion exchange cartridge becomes available to be taken out when a part on the front side of the inner fender is removed.

### TECHNICAL FIELD

The present invention relates to an ion exchanger for a vehicle carrying a fuel cell, and more particularly to an ion exchanger for a fuel cell vehicle, for removing ions in cooling water flowing through a cooling water path of the fuel cell.

### BACKGROUND ART

In a vehicle carrying a fuel cell, chemical energy is converted to electrical energy through electric-chemical reaction occurring in the fuel cell to drive the drive motor of the vehicle. Also, because the temperature of the fuel cell and drive motor on operation becomes high, a cooling device utilizing cooling water to prevent excessive heating is provided.

Generally, in a fuel cell, temperature adjustment is required for a smooth electric-chemical reaction, and thus the cooling device has not only a cooling function but also a warming function. Also, because increase in conductivity of the cooling water would result in drop of insulation, an ion exchanger is provided for removing ions in the cooling water to lower the conductivity of the cooling water.

JP No. 2005-108458A discloses a technique related to a temperature adjustment device for reducing a period of time to warm up a fuel cell. Also, JP No. 2005-125818A discloses a technique for efficiently arranging cooling system components of a fuel cell within a limited space to ensure larger freedom in layout of the cooling system components, and also for reducing the length of a pipe communicating a heat discharger and a reserve tank.

### DISCLOSURE OF INVENTION

The above-described patent documents disclose increase of freedom in layout and reduction of the pipe length. According to the documents, however, the ion exchanger for lowering the conductivity of cooling water is not conventionally mounted in a position which permits readily replacement of the ion exchanger itself.

In general, a maintenance operation at relatively short intervals is required in order to ensure insulation of the cooling water of the fuel cell. However, for an arrangement in which the ion exchanger is mounted, e.g., between a bumper and a radiator, due to limited mounting space, the bumper and the under-panel and other components connected to the bumper need to be removed when performing the maintenance operation, and many steps are accordingly required.

Also, because many components need to be removed and the vehicle is thus occupied for a long period, operation for replacing the ion exchanger will be performed according to a schedule for other jobs. This may tend to delay the time to replace the ion exchanger, promoting deterioration of the ion exchanger resin and thus resulting in a problem that ion removing capability is deteriorated.

In view of the above, one of the objects of the present invention is to provide an ion exchanger for a fuel cell vehicle, adapted to ready replacement thereof.

In order to achieve the above-described object, an ion exchanger for a fuel cell vehicle according to the present invention is an ion exchanger for a fuel cell vehicle for removing ions in cooling water flowing in a cooling water path equipped to a fuel cell mounted in the vehicle, wherein the ion exchanger is mounted in a space surrounded by a bumper and a fender both in a forward direction of the vehicle.

Also, in an ion exchanger for a fuel cell vehicle according to the present invention, the ion exchanger may comprise an ion exchange cartridge where ion exchange resin is filled, and an ion exchanger bracket for connecting the ion exchange cartridge to the cooling water path to thereby hold the ion exchange cartridge so as to be freely removed.

Further, in an ion exchanger for a fuel cell vehicle according to the present invention, in removing the ion exchange cartridge, an inner fender covering an inner side of the fender may be removed and taken out.

Still further, in an ion exchanger for a fuel cell vehicle according to the present invention, in removing the ion exchanger cartridge, an ion exchanger plug to be fitted in the ion exchange racket to block the cooling water path may be mounted on the ion exchanger bracket.

Application of the present invention makes it possible to mount the ion exchange at an outer peripheral position of the vehicle, the position permitting the ion exchanger to be readily handled from outside the vehicle. This can enhance convenience in performing the maintenance operation. Also, improvement in the manner of mounting the ion exchanger and a structure for removing the ion exchange cartridge from the ion exchanger bracket can produce an advantage that the number of required work steps is reduced.

As another advantage, in the maintenance operation, the operation for replacing the ion exchanger can be readily carried out when the inner fender alone is removed. This produces an advantage that deterioration in performance of the ion exchanger is prevented by replacing the ion exchanger at an appropriate time.

### BRIEF DESCRIPTION OF DRAWINGS

FIG. 1 shows a front view, a top view, and a side view showing a position where an ion exchanger according to an embodiment of the present invention is mounted;

FIG. 2 is an external appearance view showing external appearance of the ion exchanger comprising an ion exchanger bracket and an ion exchange cartridge according to the embodiment of the present invention;

FIG. 3 is an external appearance view showing external appearance of the ion exchange cartridge according to the embodiment of the present invention; and

FIG. 4 is a structural diagram showing a fuel cell and a cooling device for a fuel cell vehicle according to the embodiment of the present invention.

### BEST MODE FOR CARRYING OUT THE INVENTION

In the following, the best mode for rendering the present invention into practice (hereinafter referred to as an embodiment) will be described with reference to the drawings.

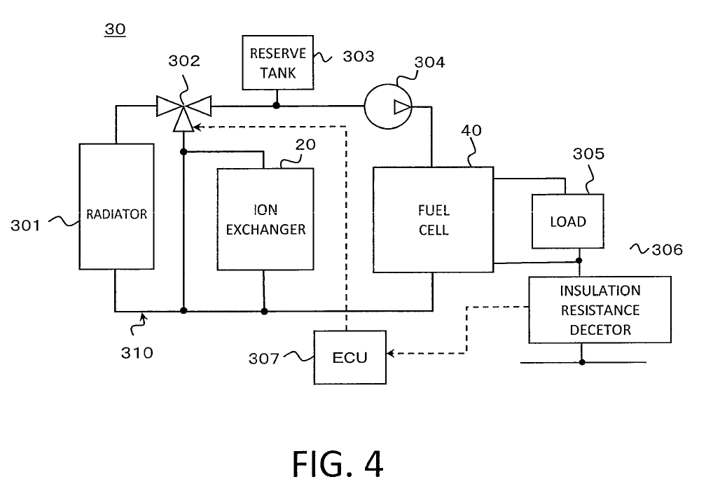

FIG. 4 is a structural diagram showing a fuel cell and a cooling device to be mounted on a fuel cell vehicle 10 according to this embodiment. The fuel cell 40 generates heat through power generation in the fuel cell, and with a temperature suitable for operation thereof being predetermined, is equipped with a cooling water path 310 for cooling the fuel cell 40, using cooling water, so that the power generation is performed at this temperature. Further, the cooling water path 310 is equipped with a radiator 301, a three-way valve 302, a reserve tank 303, and a pump 304, and the fuel cell 40 is connected to a load 305 and an insulation resistance detector 306. Further, the insulation resistance detector 306 is connected to an ECU (Electric Control Unit) 307 which controls the vehicle and three-way valve 302.

The fuel cell 40 and load 305, forming a high voltage circuit, are insulated from a vehicle body and an electric conductor located nearby in order to prevent leakage therefrom. However, increased conductivity of the cooling water due to ions in the cooling water of the fuel cell 40 could possibly lower the insulation resistance between the fuel cell 40 and vehicle. In view of the above, the ECU 307 controls the three-way valve 302 based on the resistance value detected by the insulation resistance detector 306 which measures insulation resistance to adjust the cooling water flowing in the ion exchanger 20 so that the conductivity of the cooling water is thereby controlled.

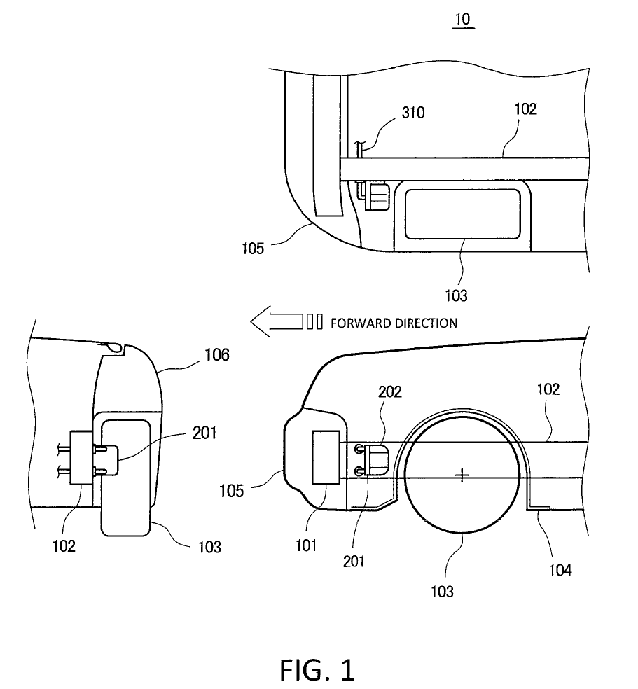

FIG. 1 shows a front view, a top view, and a side view showing a position where the ion exchanger 20 is mounted in this embodiment. Referring to FIG. 1, a mounting position of the ion exchanger 20, or one of the characteristics of the present invention, will be described.

The ion exchanger 20 comprises an ion exchange cartridge 202 and an ion exchanger bracket 201 for connecting the ion exchange cartridge 202 to the cooling water path 310 to thereby hold the ion exchange cartridge 202 so as to be freely removed. The ion exchanger bracket 201 is provided at a place closer to the front end portion 101 of the fuel cell vehicle 10, the place being on the side surface of the sub-frame 102, and the cooling water path 310, connected to the ion exchanger bracket 201, is arranged so as to reach the motor room, passing through the sub-frame 102.

Also, since the ion exchanger 20 is placed in a space surrounded by the rear side of a bumper 105 and an inner fender 104 covering the rear side of a fender 106 and a tire 103, the ion exchange cartridge 202 becomes available to be taken out for replacement when a part on the front side of the inner fencer 104 is removed. Further, since the inner fender 104 is fixed using mounting screws at some points on the bumper 105, fender 10, and tire housing, the inner fender 104 can be readily removed and attached, using only a single driver.

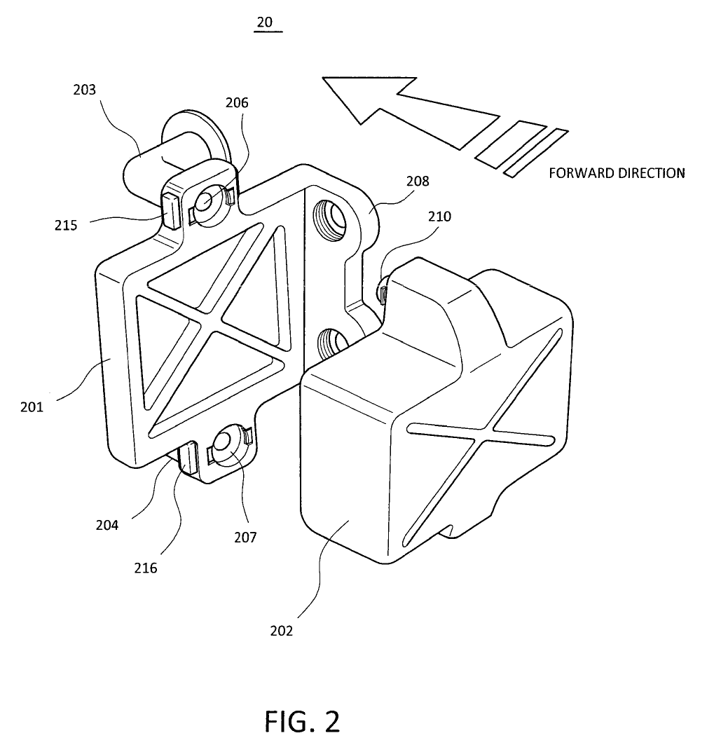

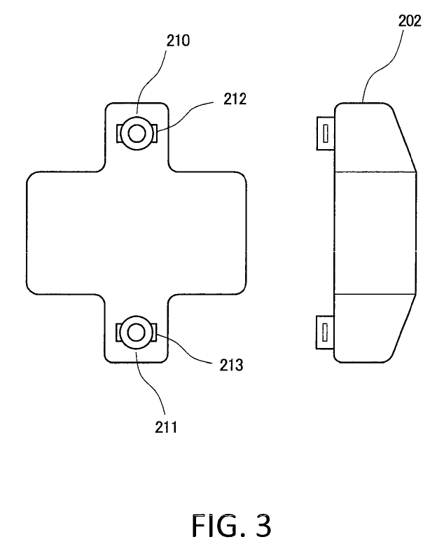

FIG. 2 shows external appearance of the ion exchanger 20 comprising the ion exchanger bracket 201 and the ion exchange cartridge 202 in this embodiment. Further, FIG. 3 is a diagram showing external appearance of the ion exchange cartridge 202. The ion exchanger bracket 201 comprises a base portion 208 for mounting on a sub-frame 102, coupling portions 206, 207 into which convex portions 210, 211 of the ion exchange cartridge 202 are inserted, and engaging portions 215, 216 with which the prong portions 212, 213 of the ion exchange cartridge 202 are engaged, and pipes 203, 204 to be connected to the cooling water path 310.

Also, the engaging portions 215, 216 each have a press button formed thereon. Pressing the press button releases the engagement so that the ion exchange cartridge 202 can be removed.

An ion exchanger plug, which is mounted to prevent leakage of the cooling water and mixing of foreign matter during operation for replacing the ion exchange cartridge 202, has, e.g., a different color from that of a typical ion exchange cartridge and a deeper depth than that of the same, so that the ion exchanger plug has a shape (not shown) which would partially interfere with the inner fender should an attempt to attach the inner fender be performed by mistake. That is, the inner fender cannot be attached to the fender while the ion exchange plug is mounted. This makes it possible to readily notice any failure of removing the inner exchange plug, which cannot be directly watched from the outside.

As described above, according to this embodiment, an ion exchange for lowering the conductivity of cooling water is mounted at a position which permits ready replacement thereof, thereby facilitating maintenance therefor.

Also, removal of many components is unnecessary, and time for occupying the vehicle is thus not long. This eliminates the need of performing operation for replacing the ion exchanger according to schedule for other jobs. This consequently produces an advantage that deterioration of ion removing capability due to advanced deterioration of ion exchanger resin can be prevented.

It should be noted that although the ion exchanger is mounted on the left side of the vehicle in the above description, the mounting position is not limited to the above, and that the ion exchange may be mounted on the right side of the vehicle.

1.-4. (canceled)

5. An ion exchanger for a fuel cell vehicle, for removing ions in cooling water flowing in a cooling water path equipped to a fuel cell mounted in the vehicle, wherein
the ion exchanger, which requires regular replacement, is mounted in a space surrounded by a bumper and a fender, both in a forward direction of the vehicle.

6. The ion exchanger for a fuel cell vehicle according to claim 5, wherein the place where the ion exchanger is mounted is a space surrounded by a bumper in a front direction of the vehicle and an inner fender covering the fender and an inner side of the fender.

7. The ion exchanger for a fuel cell vehicle according to claim 5, wherein
the ion exchanger comprises
an ion exchange cartridge where ion exchange resin is filled, and
an ion exchanger bracket for connecting the ion exchange cartridge to the cooling water path to thereby hold the ion exchange cartridge so as to be freely removed.

8. The ion exchanger for a fuel cell vehicle according to claim 7, wherein, in removing the ion exchange cartridge, an inner fender covering an inner side of the fender is removed and taken out.

9. The ion exchanger for a fuel cell vehicle according to claim 7, wherein, in removing the ion exchanger cartridge, an ion exchanger plug to be fitted in the ion exchange racket to block the cooling water path is mounted on the ion exchanger bracket.
